(19) United States
(12) Patent Application Publication
(10) Pub. No.: US 2002/0173996 A1
(43) Pub. Date: Nov. 21, 2002

(54) Method and system for asynchronously booking travel inventory

(76) Inventors: Steve Murch, Seattle, WA (US); Richmond Y. DeLorme, Bellevue, WA (US); Lucienne Fischer Campbell, Seattle, WA (US); Gretchen Kelso, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/123,051

(22) Filed: Apr. 12, 2002

Related U.S. Application Data
(60) Provisional application No. 60/283,551, filed on Apr. 12, 2001.

(51) Int. Cl. G06F 17/60

(52) U.S. Cl. 705/5

(57) ABSTRACT

The present invention enables inventory managers to participate in an on-line booking environment while not having to maintain full-time connections with an inventory server. In one embodiment, the invention comprises a consumer selecting a unit of travel inventory. Once the selected a server formats this selection into a limited availability request that is forwarded onto an inventory manager's device. The inventory manager may then respond to the limited availability by returning an availability response as to whether that particular piece of travel inventory is available at the specified dates and/or times. Note, however, that until booking is completed, the complete consumer information will not be available to an inventory manager. This ensures that the inventory server maintains the initial relationship between the consumer, as well as the relationship with the inventory manager, such that the inventory server is able to manage the interactions.

### CROSS-REFERENCE TO RELATED APPLICATION

This application claims the benefit of U.S. Provisional Patent Application No. 60/283,551 filed on Apr. 12, 2001. U.S. Provisional Patent Application No. 60/283,551 is incorporated herein by reference.

### FIELD OF THE INVENTION

The present invention relates in general to on-line booking of travel inventory and, in particular, to a system and method for asynchronously booking properties and other travel inventory on-line.

### BACKGROUND OF THE INVENTION

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”) consisting of a few computers or workstations and related devices; to a wide area network (“WAN”) which interconnects computers and LANs that are geographically dispersed; to a remote access service (“RAS”) which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”) along with higher level protocols such as the Transmission Control Protocol/Internet Protocol (“TCP/IP”) or the Uniform Datagram Packet/Internet Protocol (“UDP/IP”) to communicate with one another.

The Internet has recently seen explosive growth by virtue of its ability to link computers located throughout the world. As the Internet has grown, so has the World Wide Web (“WWW” or “Web”). The Web is a vast collection of interconnected or “hypertext” documents in HyperText Markup Language (“HTML”) that are electronically served at “Web sites” throughout the Internet. It is also one of the best known examples of a interactive hypertext environment. Other interactive hypertext environments may include proprietary environments such as those provided by America On-Line or other on-line service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention.

The Web has quickly become a popular method of disseminating information due in large part to its simplicity and its ability to deliver information in a variety of formats. To make information available over the Web, a user typically composes a set of “Web pages” which are posted on a Web site by an Internet Service Provider (“ISP”). A Web site resides on a server connected to the Internet that has mass storage facilities for storing hypertext documents, a.k.a. “Web pages,” and that runs administrative software for handling requests for those stored hypertext documents. A hypertext document normally includes a number of hyperlinks, i.e., highlighted portions of text which link the document to another hypertext document possibly stored at a Web site elsewhere on the Internet. Each hyperlink is associated with a Uniform Resource Locator (“URL”) that provides the exact location of the linked document on a server connected to the Internet and describes the document. Thus, whenever a document or file is retrieved from any Web server, the document or file is considered to be retrieved from the Web.

A user is allowed to retrieve hypertext documents from the Web, i.e., a user is allowed to “surf the Web,” via a Web browser. A Web browser, such as NETSCAPE NAVIGATOR®, MICROSOFT® Internet Explorer or phone.com's UP.link microbrowser, is a software program implemented by a Web client, i.e., the user's computer, cell phone or other consumer device, to provide a graphical user interface (“GUI”) to the Web. Upon request from the user via the Web browser, the Web client accesses and retrieves the desired hypertext document from the appropriate Web server using the URL for the document and a protocol known as HyperText Transfer Protocol (“HTTP”). HTTP is a higher-level protocol than TCP/IP and is designed specifically for the requirements of the Web. It is used on top of TCP/IP to transfer hypertext documents between servers and clients.

At the advent of the Web, the information stored on the Internet was generally static in nature and if one wanted to change the information provided on a Web site it was necessary to manually configure the Web site by rewriting its HTML code. However, at the present stage of development on the Web, many Web sites provide dynamic content that changes depending on a user's interaction between the Web browser on the user's consumer device and the Web site. These dynamic hypertext documents are well known in the art and may be produced in a myriad of different manners, such as by using Common Gateway Interface (“CGI”) scripts processed by a Web server or local scripts just as JAVAScript processed by a Web browser.

The present invention relates to network-based, and Internet-based travel services, such as a travel service offering reservations for lodging to customers over the Internet via a Web site. With such a service, a customer, using a computer connected to the travel service via the Internet, books reservations from a dynamically changing inventory. Typically, such a travel service cooperates with a centralized computer reservation system (“CRS”). A CRS is a system/service that communicates with travel agent services for the purpose of providing up-to-date rates, dates, rules (which rates are valid under which circumstances) and availability in response to a query. This information is provided to the CRS by the inventory providers, typically through third parties. However, the CRS is usually unable to provide rates, dates, and rules for smaller lodging providers because these providers are unable to provide booking information to the CRS directly.

This problem is even more prevalent in remote locations where access to the Internet or other on-line connections is intermittent at best. If both the inventory provider and the traveler have only intermittent on-line access, then there is a need for a “place” where they can conduct their business. And, in addition, it is those inventory providers at remote locations that often have the properties and/or other travel inventory such as boats, or camping locations, that are the most desirable for certain travelers.

### SUMMARY OF THE INVENTION

The limitations of prior on-line systems are overcome by the present invention, which is a method and system for asynchronously booking travel inventory on-line. In particular, the present invention enables providers of travel inventory and/or inventory managers to participate in an on-line booking environment while not having to maintain either complex or expensive full-time connections with an inventory server. By utilizing an asynchronous system (e.g., system in which rigid real-time ordering and booking requirements are not needed), more accessible networking tools, such as e-mail, can be used to notify both consumers and inventory managers on progress during the booking process.

In one embodiment, asynchronous booking starts with an inventory search query from a consumer. A list of possible travel inventory selections is then retrieved in response to the search query and presented to the consumer on a client device. The consumer is then able to request further information on any of the possible travel inventory selections. Once the consumer makes a selection, it is then listed on an on-line itinerary for the consumer. If the inventory selection is one that uses asynchronous booking then the on-line inventory would list the selection as pending until booking has been completed. The selection process includes generating an availability request from the consumer's client device for the travel inventory selection. This availability request is then formatted into a limited availability request that is forwarded onto an inventory manager's device. The inventory manager may then respond to the limited availability request by accessing the inventory server and returning an availability response as to whether that particular piece of travel inventory is available at the specified dates and/or times.

Usually, accessing the inventory server would entail the inventory manager logging in to their inventory manager account on the inventory server so that they can see any pending availability requests. The inventory manager, once logged in, is also able to request further information about the availability requests. Note, however, that until booking is completed, the complete availability request and consumer information will not be available to an inventory manager. This ensures that the inventory server the initial relationship between the consumer and inventory server. Additionally, it maintains the relationship between the inventory manager and the inventory server such that the inventory server is able to manage the interactions between the consumer and inventory manager for both quality and business purposes.

Once the inventory manager has made a determination on availability for the selected inventory in the limited availability requests, the inventory manager may then asynchronously respond to the limited availability request with an availability response. The availability response will generally include either a confirmation that the inventory is available for the specified dates and/or times but may include alternate dates and/or times or alternate inventory if the initially requested inventory selection is not available. This availability response is then used to update the consumer's on-line itinerary as well as to notify the consumer as to the availability of their selected travel inventory.

If the consumer had initially provided payment information to the inventory server, then that information is forwarded back to the inventory manager and confirmations are sent to both the consumer and inventory manager that the selected inventory has been booked. If, however, the consumer did not initially provide payment information, then they may provide payment information within a predetermined time limit to complete the booking of the selected travel inventory, after which confirmations are then sent to both the consumer and inventory manager.

In an additional aspect of the present invention, there may be circumstances in which an inventory manager fails to respond to a limited availability request. If after a predetermined interval no availability response is received from the inventory manager, then the inventory server will notify the consumer that that particular travel inventory selection is not available. Additionally, the travel inventory server will track the failure rate for the particular inventory manager. In one embodiment of the present invention, if the failure rate reaches a predetermined level, then the inventory manager and all its inventory will be suspended from listing at the inventory server. Additionally, the inventory server may notify an administrator if the inventory manager has failed to respond a predetermined number of times.

As will be readily appreciated, the foregoing summary of the invention provides for a new and improved method, system and computer readable medium for asynchronously booking travel inventory in a way that improves inventory managers' to on-line booking. Additionally, it will be appreciated the forgoing summary of the invention would allow consumers to have access to heretofore unavailable travel inventory.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 (prior art) is an illustration of a representative portion of an internetwork such as the Internet.

FIG. 2 is a pictorial diagram of a number of devices connected to an internetwork which allow a client device to engage in asynchronous booking of travel inventory in accordance with the present invention.

FIG. 3 is a block diagram illustrating several components of the client device shown in FIG. 2 used to engage in asynchronous booking of travel inventory in accordance with the present invention.

FIG. 4 is a block diagram illustrating several of the components of an agent server shown in FIG. 2 used to communicate between a client device and an inventory server in accordance with the present invention.

FIG. 5 is a block diagram illustrating several of the components of an inventory server shown in FIG. 2 and used to communicate between a client device and/or agent server and an inventory manager device to book travel inventory asynchronously in accordance with the present invention.

FIG. 6 is a block diagram illustrating several components of the inventory manager device shown in FIG. 2 and used to book travel inventory asynchronously in accordance with the present invention.

FIG. 7 is a diagram illustrating the actions taken by a client device, inventory server, inventory database and an inventory manager device to search for and asynchronously book travel inventory in accordance with the present invention.

FIG. 8 is an overview flow diagram illustrating an availability search routine implemented by either the agent server or the inventory server to search for travel inventory in accordance with the present invention.

FIG. 9 is an overview flow diagram illustrating an inventory manager response routine implemented by the inventory manager device to respond to a request for the availability of a travel inventory selection in accordance with the present invention.

FIG. 10 is an overview flow diagram illustrating an inventory manager processing routine implemented by the inventory server for processing an inventory manager's actions in accordance with the present invention.

FIG. 11 is an overview flow diagram illustrating an inventory manager response processing subroutine used to process an inventory manager's response to an availability request in accordance with the present invention.

FIG. 12 is a diagram illustrating the actions taken by a client device, agent server, agent database, inventory server, inventory database, and an inventory manager device for searching asynchronous booking of a travel inventory selection in accordance with the present invention.

FIGS. 13-15 show exemplary Web pages for searching and selecting travel inventory for a consumer in accordance with the present invention.

FIGS. 16-19 show exemplary Web pages for allowing an inventory manager to respond to consumer availability requests in accordance with the present invention.

### DETAILED DESCRIPTION OF THE PREFERRED EMBODIMENT

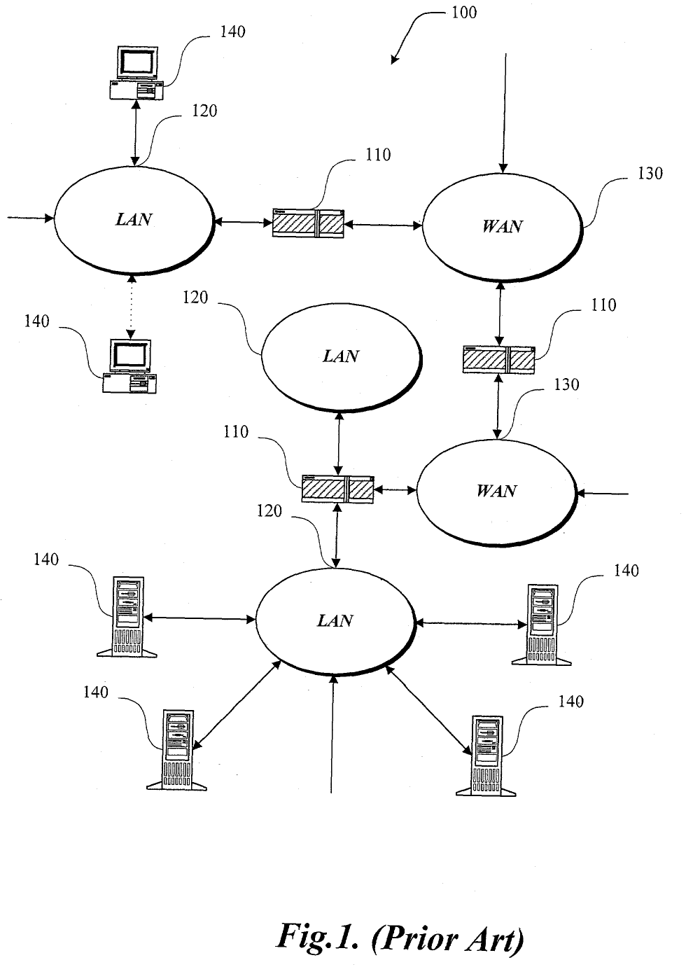

As previously explained, the capitalized term “Internet” refers to the collection of networks and routers that use the Internet Protocol (“IP”) to communicate with one another. A representative section of the Internet 100 is shown in FIG. 1 (Prior Art) in which a plurality of LANs 120 and WANs 130 are interconnected by routers 110. The routers 110 are generally special purpose computers used to interface one LAN or WAN to another. Communication links within the LANs may be twisted pair wire, or coaxial cable, while communication links between networks may utilize 56 Kbps analog telephone lines, or 1 Mbps digital T-1 lines and/or 45 Mbps T-3 lines. Further computers and other related electronic devices can be remotely connected to either the LANs 120 or the WAN 130 via a modem and temporary telephone link. Such computers and electronic devices 140 are shown in FIG. 1 as connected to one of the LANs 120 via dotted lines. It will be appreciated that the Internet comprises a vast number of such interconnected networks, computers and routers and that only a small, representative section of the Internet 100 is shown in FIG. 1.

The Web, on the other hand, is a vast collection of interconnected, electronically-stored information or “content” located on servers connected throughout the Internet 100. Many companies are now providing services and access to their content over the Internet 100 using the Web. For example, a number of companies provide travel services via the Internet 100 that enable customers to make reservations on-line for transportation and lodging. In accordance with the present invention, an optimized system and method are provided that determine the best available travel packages in response to a package query made by a user who is considering making a reservation and purchasing tickets for transportation, lodging, entertainment, etc., on-line. While air carriers and flights are used herein as illustrative examples of transportation for purposes of discussion of the present invention, it would be appreciated by those of ordinary skill in the art that the present invention applies equally as well to other forms of transportation as well, such as rail, road, water or any other form of transportation amenable to reservations inquiry. Furthermore, the present invention could be applied to pricing products which combine travel with related products such as hotel stays or car rentals; as selecting low price products from a large number of possible combinations is important in this market. Still, further, the present invention could be applied to non-passenger travel as well, inasmuch as package routing and delivery might benefit from travel package searching to increase efficient delivery of packages for the least cost.

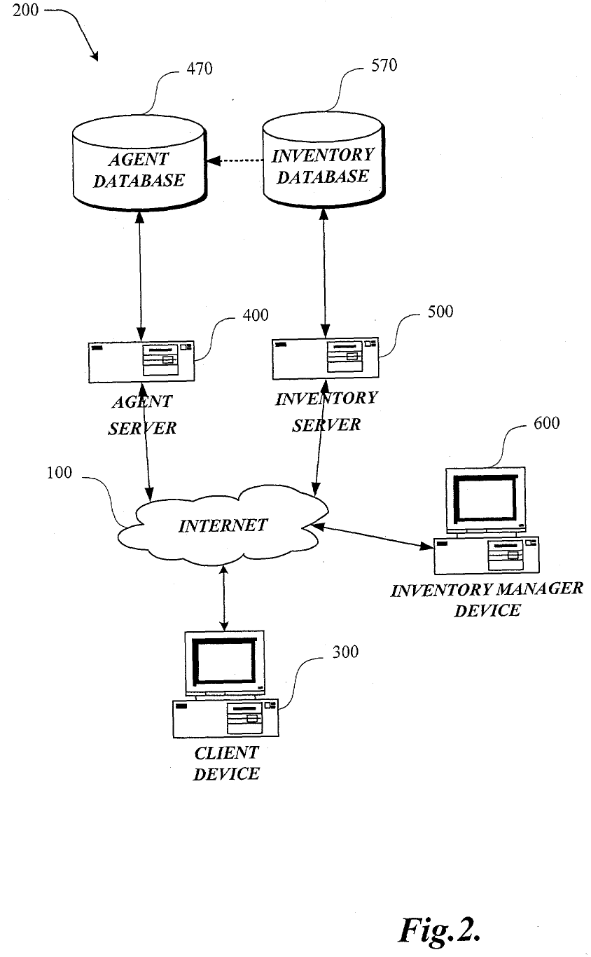

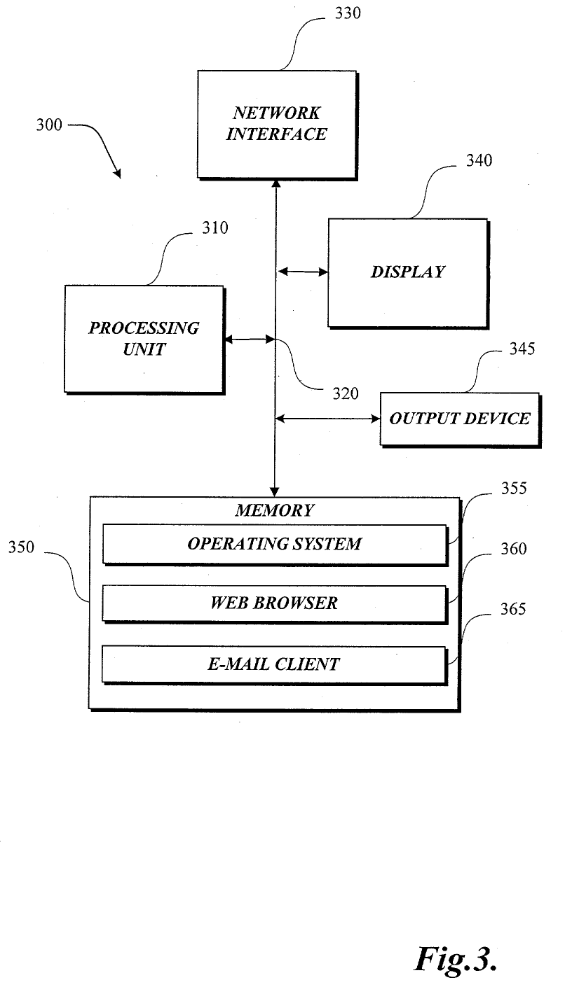

FIG. 2 illustrates a functional block diagram of a system 200 for asynchronously booking a travel selection in response to a query made by the user of the client device 300. The system 200 generally operates in a distributed computed environment comprising individual computer systems connected over a network (such as the Internet 100). However, it will be appreciated by those of ordinary skill in the art, the system could equally function with less devices than shown in FIG. 2 or even as a single, stand alone computer system. In the described embodiment, a client device 300, an agent server 400, an inventory server 500, and an inventory manager device 600 are interconnected over an internetwork such as the Internet 100 or perhaps even over an intranetwork. Additionally, FIG. 2 includes an agent database 470 and an inventory database 570. The client device 300, the agent server 400, the travel server 500, and the inventory manager device 600, are further described below in relation to FIGS. 3, 4, 5, and 6, respectively. Those of ordinary skill in the art will appreciate that more or less devices may be used in the exemplary system 200. For example, while only one client device 300 has been shown, it will be appreciated that many client devices may be used in system 200. Additionally, the system 200 may include many agent servers 400 as well. By using agent servers 400, the present invention is able to more efficiently manage processing and bandwidth resources by distributing the processing and bandwidth amongst the agent servers 400. Additionally, each agent server 400 may beneficially provide its own branded presence, thereby increasing awareness in the marketplace.

FIG. 3 depicts several of the key components of the client device 300. Those of ordinary skill in the art will appreciate that the client device 300 may include many more components than those shown in FIG. 3. However, it is not necessary that all of these generally conventional components be shown in order to disclose an enabling embodiment for practicing the present invention. As shown in FIG. 3, the client device 300 includes a network interface 330 for connecting to the Internet 100. Those of ordinary skill in the art will appreciate that the network interface 330 includes the necessary circuitry for such a connection, and is also constructed for use with the TCP/IP protocol or other protocols such as the Internet Inter-ORB Protocol (“IIOP”).

The client device 300 also includes a processing unit 310, a display 340, an output device 345 and a memory 350 all interconnected along with the network interface 330 via a bus 320. The output device 345 could be any type of device capable of receiving output from the client device 300, such as, but not limited to, a printer, a smart card reader, a plotter or a storage mechanism like a floppy, tape or DVD/CD-ROM drive. The memory 350 generally comprises a random access memory (“RAM”), a read-only memory (“ROM”) and a permanent mass storage device, such as a disk drive. The memory 350 stores a Web browser 360, or e-mail client 365, and an operating system 355. It will be appreciated that these software components may be loaded from a computer-readable medium into memory 350 of the client device 300 using a drive mechanism (not shown) associated with the computer-readable medium, such as a floppy, tape or DVD/CD-ROM drive or via the network interface 330.

Although an exemplary client device 300 has been described that generally conforms to a conventional general purpose computing device, those of ordinary skill in the art will appreciate that a client device 300 may be any of a great number of devices capable of communicating with the Internet 100 or with the agent server 400.

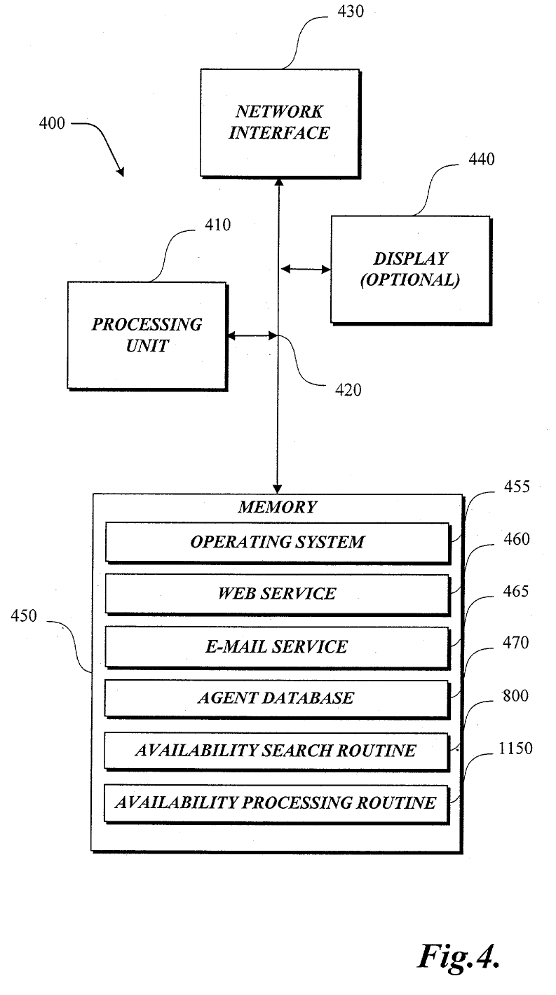

FIG. 4 depicts several of the key components of the agent server 400. Those of ordinary skill in the art will appreciate that the agent server 400 includes many more components then those shown in FIG. 4. However, it is not necessary that all of these generally conventional components be shown in order to disclose an enabling embodiment for practicing the present invention. As shown in FIG. 4, the agent server 400 is connected to the Internet 100 via a network interface 430. Those of ordinary skill in the art will appreciate that the network interface 430 includes the necessary circuitry for connecting the agent server400 to the Internet 100, and is also constructed for use with the TCP/IP protocol or other protocols, such as the IIOP, the particular network configuration of the operating environment in which it is contained and a particular type of coupling medium.

The agent server 400 also includes a processing unit 410, an optional display 440, and a mass memory 450 all interconnected along with the network interface 430 via a bus 420. The memory 450 generally comprises RAM, ROM, and one or more permanent mass storage devices, such as a hard disk drive, tape drive, optical drive, floppy disk drive, or combination thereof. The mass memory 450 stores the program code and data necessary for receiving, processing, formatting and sending messages, as well as, supplying the results of that processing in accordance with the present invention. More specifically, the memory 450 stores a Web service 460 for providing connectivity to the Web for computers with Web browsers, such as the client device 300 having Web browser 360. Additionally, the memory 450 stores an availability search routine 800 for searching for available bookings for a consumer and an availability processing routine 1150 for processing inventory manager responses in accordance with the present invention.

It will be appreciated that the aforementioned software components may be loaded from a computer-readable medium into mass memory 450 of the agent server 400 using a drive mechanism (not shown) associated with the computer-readable medium, such as floppy, tape or DVD/CD-ROM drive or via the network interface 430.

Although an exemplary agent server 400 has been described that generally conforms to a conventional general purpose computing device, those of ordinary skill in the art will appreciate that a agent server 400 may be any of a great number of devices capable of communicating via the Internet 100, or providing Web pages over a network.

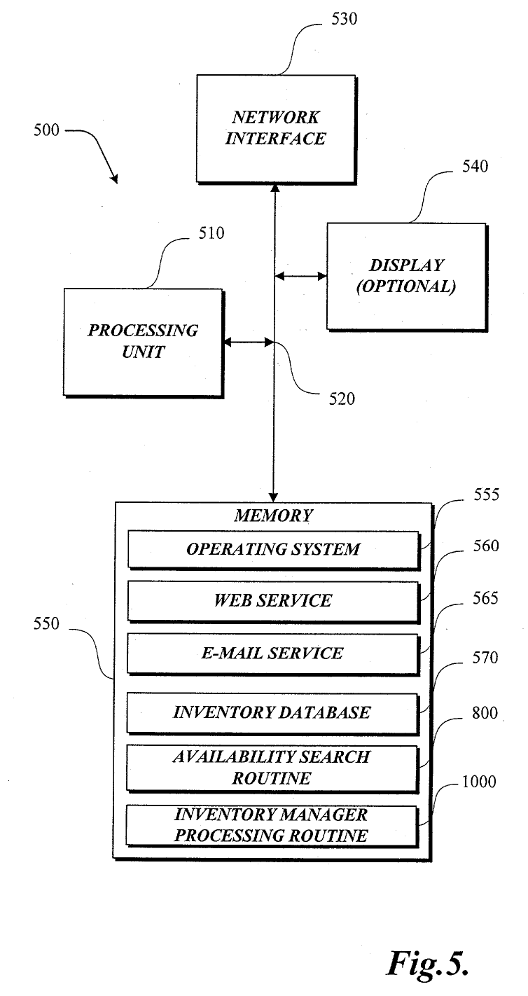

FIG. 5 depicts several of the key components of the inventory server 500. Those of ordinary skill in the art will appreciate that the inventory server 500 includes many more components then those shown in FIG. 5. However, it is not necessary that all of these generally conventional components be shown in order to disclose an enabling embodiment for practicing the present invention. As shown in FIG. 5, the inventory server 500 is connected to the Internet 100 via a network interface 530. Those of ordinary skill in the art will appreciate that the network interface 530 includes the necessary circuitry for connecting the inventory server 500 to the Internet 100, and is also constructed for use with the TCP/IP protocol or the next generation protocols, such as the IIOP, the particular network configuration of the operating environment in which it is contained and a particular type of coupling medium.

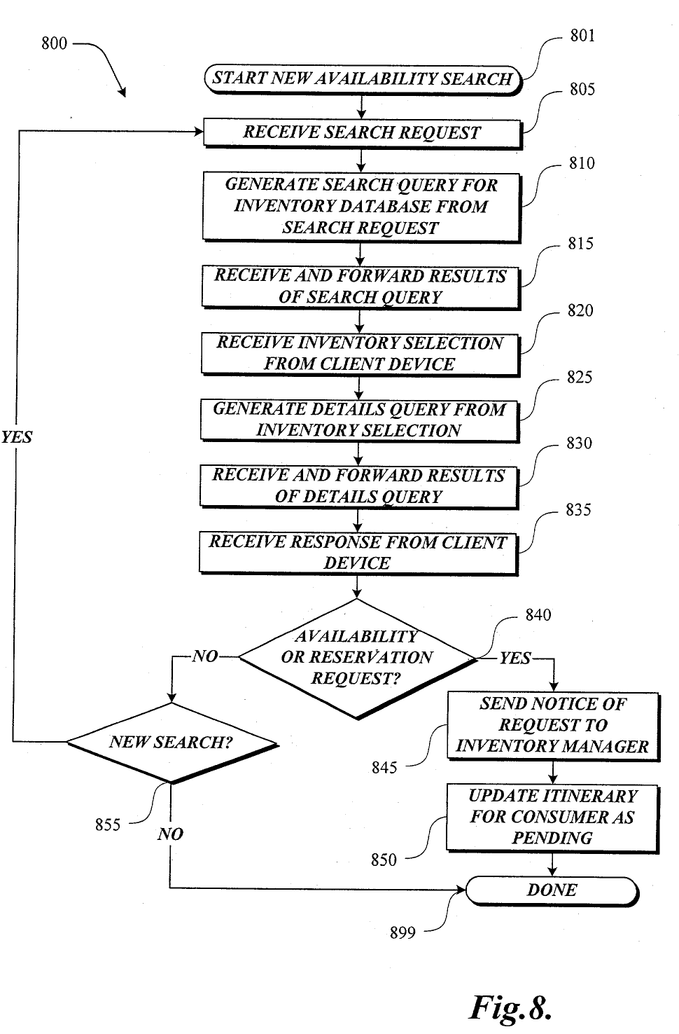

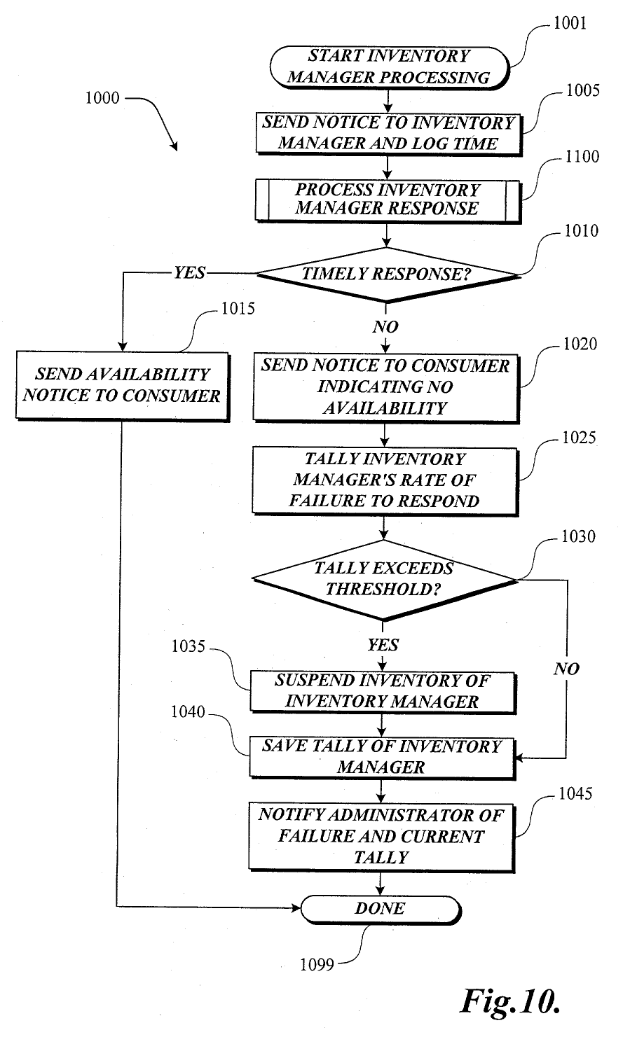

The inventory server 500 also includes a processing unit 510, an optional display 540, and a mass memory 550 all interconnected along with the network interface 530 via a bus 520. The memory 550 generally comprises RAM, ROM, and one or more permanent mass storage devices, such as a hard disk drive, tape drive, optical drive, floppy disk drive, or combination thereof. The mass memory 550 stores the program code and data necessary for receiving, processing, formatting and sending messages, as well as, supplying the results of that processing in accordance with the present invention. More specifically, the memory 550 stores an e-mail service 565 for handling electronic mail, and an inventory database 570 of travel inventory items/units. Also in memory 550 is an availability search routine 800 for searching travel inventory, and described in greater detail below with regard to FIG. 8. Additionally, memory 550 includes an inventory manager processing routine 1000 for processing responses from an inventory manager device 500, inventory manager processing routine 1000 is described in detail below with regard to FIG. 10. It will be appreciated that the aforementioned software components may be loaded from a computer-readable medium into mass memory 550 of the inventory server 500 using a drive mechanism (not shown) associated with the computer-readable medium, such as floppy, tape or DVD/CD-ROM drive or via the network interface 530.

Although an exemplary inventory server 500 has been described that generally conforms to a single conventional general purpose computing device, those of ordinary skill in the art will appreciate that a inventory server 500 may be a combination of computing devices or components, coordinated to communicate with the agent server 400 and client device 300 over a network.

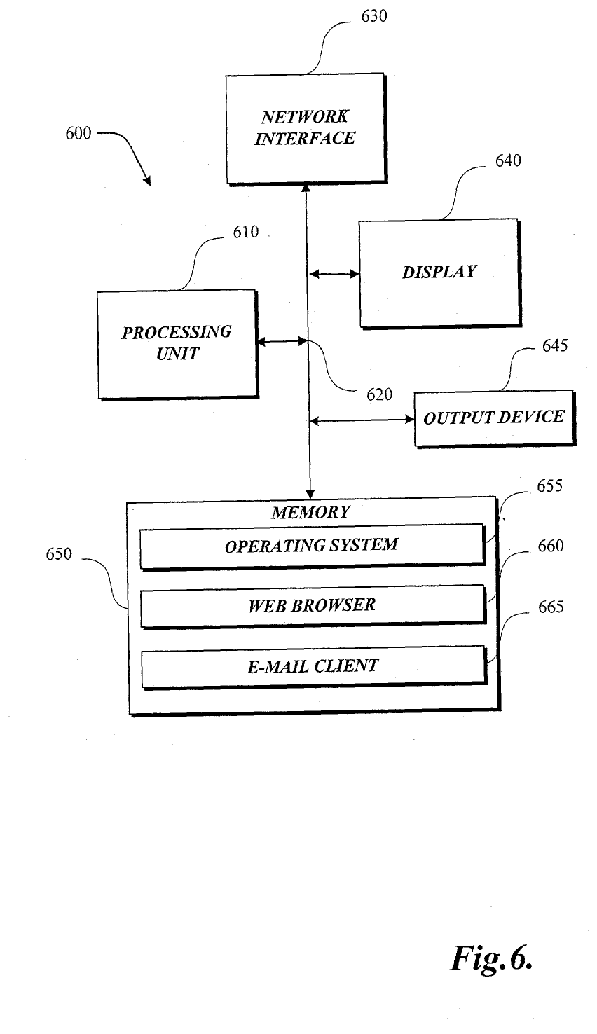

FIG. 6 depicts several of the key components of the client device 600. Those of ordinary skill in the art will appreciate that the client device 600 may include many more components than those shown in FIG. 6. However, it is not necessary that all of these generally conventional components be shown in order to disclose an enabling embodiment for practicing the present invention. As shown in FIG. 6, the client device 600 includes a network interface 630 for connecting to the Internet 100. Those of ordinary skill in the art will appreciate that the network interface 630 includes the necessary circuitry for such a connection, and is also constructed for use with the TCP/IP protocol or other protocols such as IIOP.

The client device 600 also includes a processing unit 610, a display 640, an output device 645 and a memory 650 all interconnected along with the network interface 630 via a bus 620. The output device 645 could be any type of device capable of receiving output from the client device 600, such as, but not limited to, a printer, a smart card reader, a plotter or a storage mechanism like a floppy, tape or DVD/CD-ROM drive. The memory 650 generally comprises RAM, ROM and a permanent mass storage device, such as a disk drive. The memory 650 stores a Web browser 660, or e-mail client 665, and an operating system 655. It will be appreciated that these software components may be loaded from a computer-readable medium into memory 650 of the client device 600 using a drive mechanism (not shown) associated with the computer-readable medium, such as a floppy, tape or DVD/CD-ROM drive or via the network interface 630.

Although an exemplary client device 600 has been described that generally conforms to a conventional general purpose computing device, those of ordinary skill in the art will appreciate that a client device 600 may be any of a great number of devices capable of communicating with the Internet 100 or with the agent server 400.

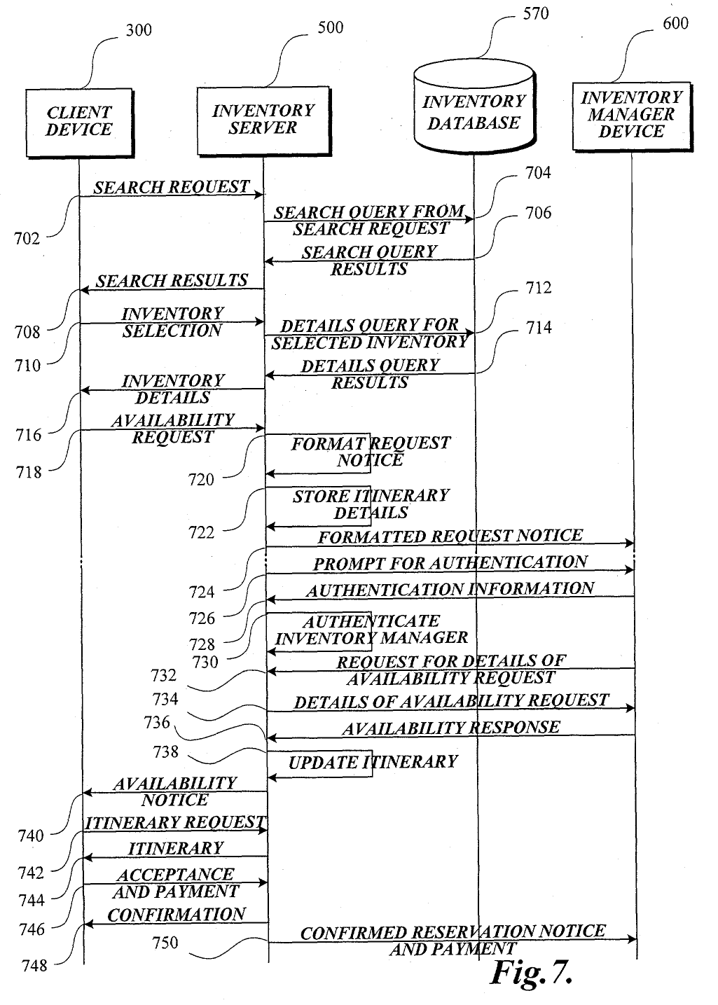

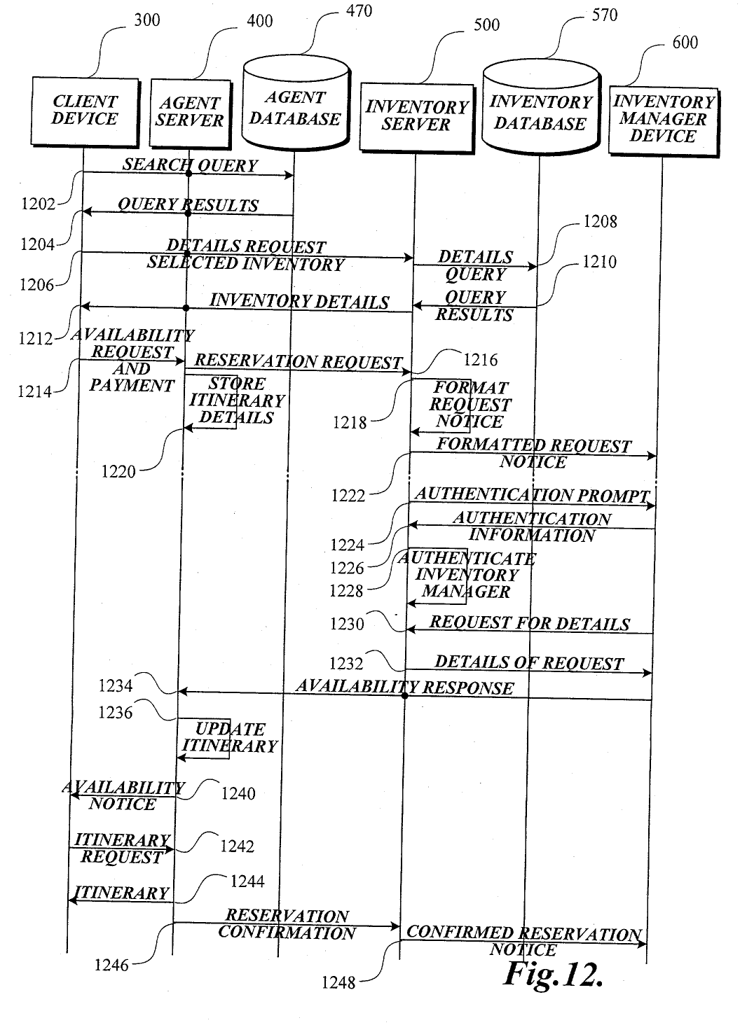

To better illustrate the operation of asynchronous bookings of travel inventories, FIG. 7 illustrates one embodiment of interactions between the devices of the asynchronous booking system 200 for asynchronously booking travel inventory. While lodging in vacation homes is used below to describe illustrative asynchronous booking of travel inventory, those of ordinary skill in the art will appreciate that the present invention applies equally well to other forms of travel inventory such as hotel rooms, bed and breakfasts, on ship lodging and/or tours, as well as, train travel and other travel inventory. The devices of system 200, illustrated in FIG. 7, include a client device 300, inventory server 500, inventory database 570, and an inventory manager device 600. The interactions and the routines performed by the various devices are illustrated and described in greater detail with reference to FIGS. 8-11. Additionally, an alternate embodiment, similar to the embodiment shown in FIG. 7, but including the use of an agent server 400 and agent database 470 is illustrated below in FIG. 12.

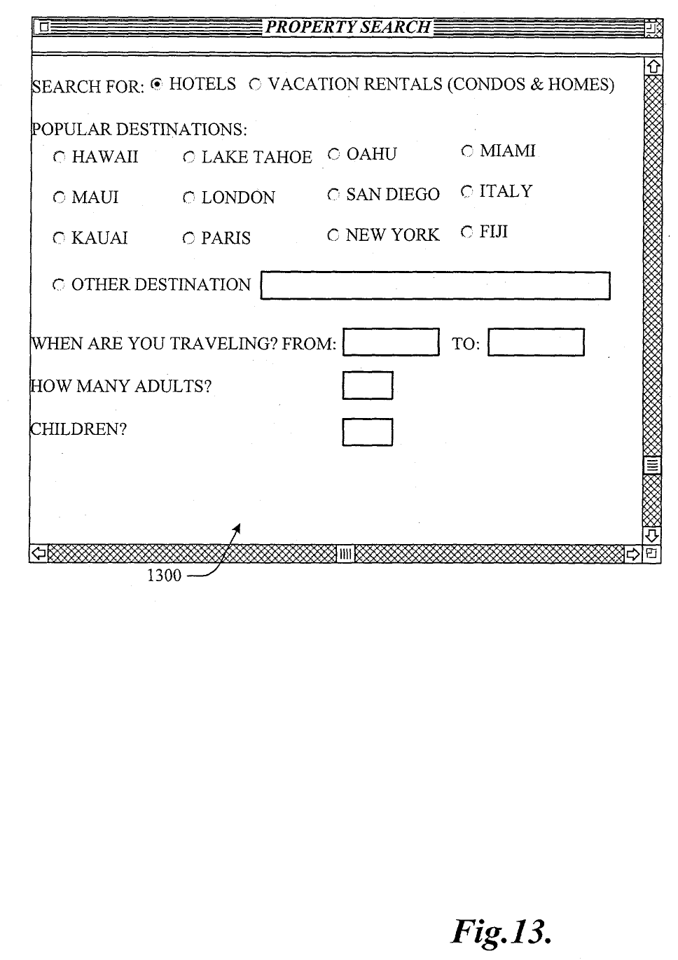

Returning to FIG. 7, asynchronous booking of travel inventory is initiated when a client device 300 sends a search request 702 to the inventory server 500 via a Web page (such as Web page 1300 illustrated in FIG. 13). Once the inventory server 500 receives the search request 702, it sends out a search query 704 to an inventory database 570. The inventory database 570 returns search query results 706 to the inventory server 500. These results are then forwarded as search results 708 back to the client device 300, thereby allowing the consumer to view the inventory that matches their search request 702. Next the consumer makes a selection and requests details in an inventory selection and details request 710 sent to the inventory server 500. The inventory server 500 in turn submits a details query 712 to the inventory database 570, which returns details query results 714 to the inventory server 500. These inventory details 716 are then forwarded to the client device 300. Assuming the consumer decides they wish to request a booking for the resulting inventory from the details query results, they submit an availability request 718 from the client device 300 to the inventory server 500. The inventory server 500 then formats a request notice 720 and also stores itinerary details 722 for the availability request. The formatted request notice 724 is forwarded to an inventory manager device 600. While the formatted request is shown in FIG. 7 as being communicated directly to an inventory manager device 600, those of ordinary skill in the art will appreciate that the formatted request notice may be communicated via electronic mail or some other communication which is not immediately communicated to the inventory manager device 600 until actions are initiated on the inventory manager device 600 to retrieve such communications. Accordingly, as shown in FIG. 7, there are broken lines in the diagram to illustrate potential passage of time between sending the formatted request notice 724 and any response by the inventory manager device 600, thereby rendering any reply from the inventory manager asynchronous. In the embodiment illustrated in FIG. 7, the inventory manager device 600 may then access the inventory server 500 which prompts the inventory manager device for authentication 726. Authentication information 728 is returned to the inventory server 500 which then authenticates 730 the inventory manager.

After authentication, the inventory manager device submits a request for details 732 of the availability request associated with the formatted request notice sent previously. The details 734 of the availability request are then returned as a limited availability request to the inventory manager device 600. The limited availability request does not specify any contact information for the consumer, thereby assuring that the inventory manager must still communicate via the inventory server 500 to book the inventory with the consumer. Once the inventory manager associated with the inventory manager device 600 has received the limited availability request, he/she is then able to determine how best to respond. Accordingly, the inventory manager device 600 sends an availability response 736 to the inventory server 500. This availability response is used to update 738 the itinerary of the consumer who initially submitted the availability request to reflect the new status (e.g., available, not available, or alternate inventory proposed and still pending). The inventory server 500 then sends an availability notice 740 detailing the availability of the requested inventory to the client device 300. To gather further information, the consumer may use the client device 300 to access their itinerary through an itinerary request 742 to the inventory server 500, which returns their on-line itinerary 744 back to the client device 300. Once the consumer decides to accept the booking of the travel inventory in accordance with the inventory manager's availability response 736, they submit their acceptance and payment information 746 to the inventory server 500. The inventory server 500 then sends out a confirmation 748 back to the client device 300 and a confirmed reservation notice and payment information 750 to the inventory manager device 600. Note, in the current embodiment of the present invention, illustrated in FIG. 7, the inventory server 500 does not process any payment, rather it merely forwards payment information to the inventory manager device 600 for processing on the inventory manager's end.

As illustrated in FIGS. 2, 5, and 7, the asynchronous inventory booking system 200 of the present invention includes an inventory server 500 that is used to search for and coordinate the asynchronous booking of travel inventory requested by a client device 300. A flow chart illustrating an inventory search routine 800 implemented by the inventory server 500, in accordance with one embodiment of the present invention, is shown in FIG. 8. The new availability search routine 800 begins in block 801 and proceeds to block 805 where a search request is received from a client device 300.

The search request is used in block 810 to generate a search query for an inventory database 570. (Alternatively, if the availability search is being performed on an agent server 400 then the search query would be directed to an agent database 470). The results of the search query are then received and forwarded back to the client device 300 in block 815. In block 820 an inventory selection is received back from the client device 300. The inventory server 500 may then generate a details query from the information in the inventory selection in block 825. The results of the details query are received in block 830 and are forwarded onto the client device 300. In block 835 a response is received from the client device 300. In decision block 840 the response from the client device is examined to determine if it is an availability or a reservation request. An availability request merely identifies the inventory unit and dates and/or times in which the consumer is interested in receiving availability information. A reservation request, however, also includes payment information such that once an inventory manager responds with an affirmative response of availability for the dates and/or times specified for the selected inventory then a confirmation can be issued without further consumer actions. Accordingly, if the response from the consumer device is either an availability or reservation request, notice of the request is sent, in block 845, to the inventory manager 600. In block 850 the consumer's itinerary is updated with a pending notice. Routine 800 then ends at block 899. However, if in decision block 840 it was determined that the consumer's response was neither an availability or a reservation request then in decision block 855 a determination is made whether a new search was requested. If so, then processing continues back to block 805 and another availability search is conducted. However, if in decision block 855 no new search request was received then processing ends at block 899.

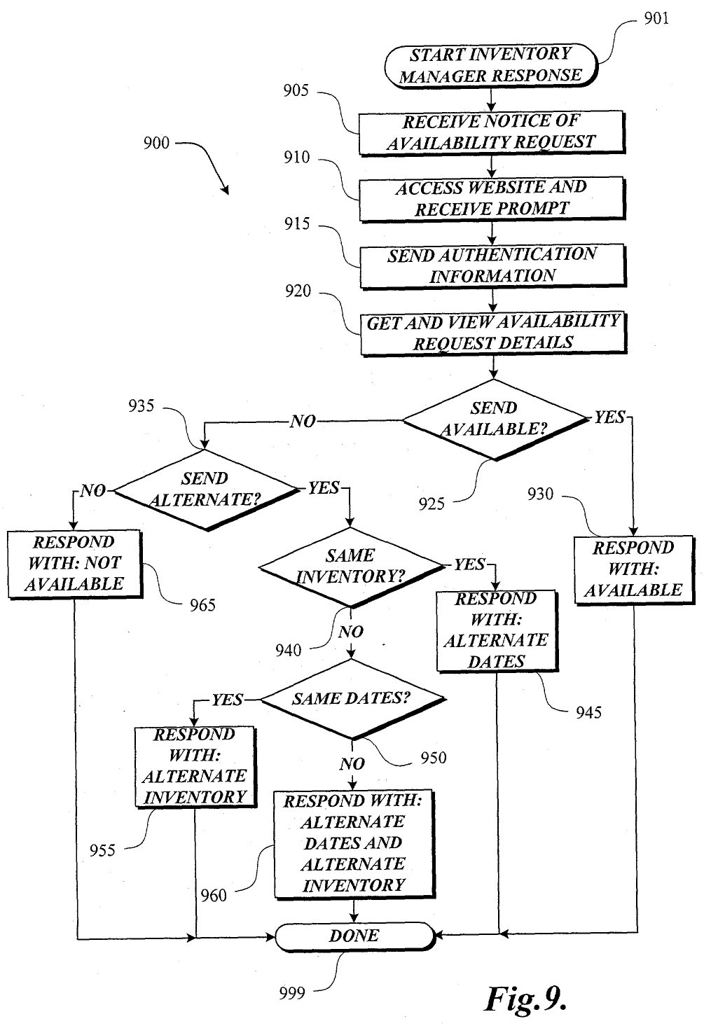

As illustrated in FIGS. 2, 6, and 7, the asynchronous booking system 200 of the present invention also includes an inventory manager device 600 that is used by the inventory manager to asynchronously book its travel inventory. A flow chart illustrating an inventory manager response process 900 utilizing such an inventory manager device 600 is shown in FIG. 9. The inventory manager process 900 begins in block 901 and proceeds to block 905, where a notice of availability request is received from the inventory server 500. Next, the inventory manager device accesses a Web site or other interface at the inventory server 500 and is prompted for authentication in block 910. Next, in block 915 authentication information is submitted to the inventory server 500 in response to a prompt from the inventory server 500. Once authenticated, the inventory manager gets and views availability request details describing the consumer's limited availability request (e.g., containing no contact information for the consumer) from the inventory server 500 in block 920. In response to these details, the inventory manager may then send a number of different responses (e.g., available, unavailable, alternate dates, etc.). Accordingly, in decision block 925 a determination is made whether to send the dates and/or times specified in the limited availability request. If dates and times are to be sent, a response of available is sent back to the inventory server 500 in block 930 and processing ends at block 999. However, if a determination was made in decision block 925 not to send an available response, then in decision block 935 a determination is made whether to send an alternate possible booking. If no alternate is to be sent then processing continues to block 965 where a response of not available is sent to the inventory server 500.

If, however, a determination was made in decision block 935 that an alternate booking will be sent, a determination is made in decision block 940 whether the alternate booking is for the same inventory and if so, then in block 945 a response is sent specifying the same inventory but with alternate dates and/or times. If, however, a determination was made in decision block 940 that the same inventory is not to be used, processing continues to decision block 950 where a determination is made whether the same dates and/or times are to be used. If so, a response with alternate inventory for the same dates and/or times is provided in a block 955. If, however, it was determined in decision block 950 that the same dates and/or times would not be used, alternate inventory and alternate dates and/or times are submitted back to the inventory server 500 in block 960. In any case, processing then ends at block 999.

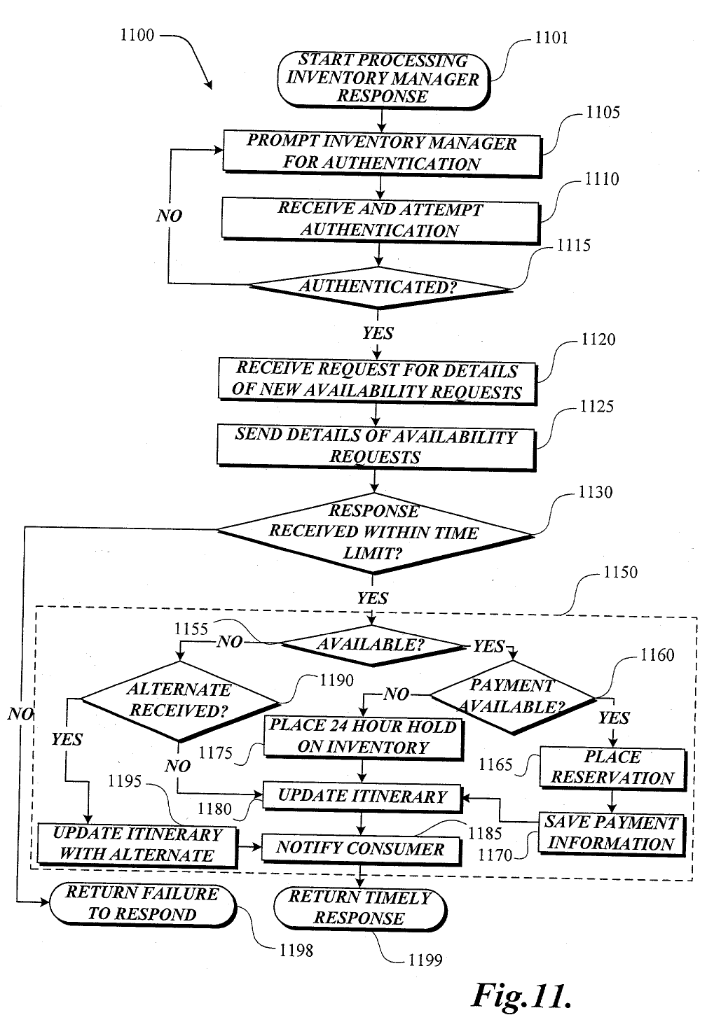

FIG. 10 illustrates an inventory manager processing routine 1000. Routine 1000 begins at block 1001 and proceeds to block 1005 where a notice of a limited availability request is sent to the inventory manager device 600 and the time is logged for timeliness purposes. Next, in subroutine block 1100 the inventory manager's response to the limited availability request is processed. Note, it will be appreciated by those of ordinary skill in the art that the inventory manager response processing subroutine 1100 may occur asynchronously with other actions on the inventory server 500 (which actions are illustrated in greater detail with regard to FIG. 11 below). However, once the inventory manager response subroutine 1100 returns, a determination is made in decision block 1010 whether the inventory manager response subroutine returned a timely response. If so, the availability notice is sent in block 1015 to a consumer at their client device 300 and processing ends at block 1099. However, if a determination was made in block 1010 that a timely response was not received from the inventory manager, a notice is sent to the consumer at their client device 300 in block 1020 indicating that there was no availability for the selected inventory. Next, in block 1025, a tally is made of the manager's failure rate to respond to availability requests. In decision block 1030 a determination is made whether the inventory manager's failure rate tally exceeds a predetermined threshold (such as three failures) and if so, then in block 1035 both the inventory and the inventory manager are suspended (e.g., their inventory would no longer be listed by the inventory server 500) until reinstated by an administrator of the inventory server 500. In any case or if in decision block 1030 the tally of the failure rate does not exceed a predetermined threshold, processing continues to block 1040 where the tally of the failure rate of the inventory manager is saved for future use. Next, in block 1045 an administrator of the inventory server 500 is notified of the failure to send a timely response and also of the inventory manager's current failure rate. Routine 1000 then ends at block 1099.

The inventory manager response processing subroutine 1100, introduced above, is illustrated in FIG. 11. The inventory manager response processing subroutine 1100 is called each time the inventory manager submits a response to the inventory server 500 to an availability request, and the results of which are used to update the consumer's itinerary. Subroutine 1100 starts in block 1101 and proceeds to block 1105 where the inventory manager is prompted for authentication. Next, in block 1110 the authentication information is received and an authentication is attempted using the received authentication information. Authentication may be made by comparison to stored information, or other conventional methods of authentication. In decision block 1115 a determination is made whether the authentication information provides authentication for the inventory manager. If not, then processing continues back to 1105 where the inventory manager is prompted again. If, however, a determination is made in decision block 1115 that the inventory manager was authenticated, processing continues to block 1120 where the inventory server 500 receives a request for details of limited availability requests from the inventory manager device 600. In block 1125 the details of the limited availability requests are sent back to the inventory manager device 600. Next, in decision block 1130 a determination is made whether the inventory manager has responded to limited availability request within a predetermined time limit. If not, then processing continues to block 1198 where a failure to respond is returned to the calling routine. However, if the inventory manager did respond within the predetermined time limit (e.g., within 48 hours or within some other reasonable reply period) then from decision block 1130 processing continues to decision block 1155.

Note in FIG. 11 there is a section of subroutine 1100 in a dotted box 1150. This section of subroutine 1100 is surrounded by dotted box 1150 to indicate that in one embodiment of the present invention the highlighted section is performed by the agent server 400 as opposed to the inventory server 500.

Returning to decision block 1155, a determination is made as to whether the response from the inventory manager device was that the specified inventory was available. If so, a determination is made in decision block 1160 whether payment information was already submitted by the consumer. If in decision block 1160 it was found that payment information has already been submitted and is available, processing continues to block 1165 where the reservation for the selected inventory is placed and the payment information is saved for transmission to the inventory manager device 600. Processing then continues to block 1180. If, however, in decision block 1160 it was found that payment was not available, a 24-hour hold is placed in block 1175 on the selected inventory to give the consumer time to respond possibly with payment information or other information to confirm the booking. It will be appreciated by those of ordinary skill in the art that while 24 hours is specified in FIG. 11 as the holding period, any period of predetermined length desired by the travel service provider may be used.

Returning again to decision block 1155, if it was determined that the inventory manager has not responded with “available” then in decision block 1190 a determination is made whether an alternate possible booking was received. If an alternate booking was not received then processing continues to block 1180 where the consumer's itinerary is updated as to their selected inventory. If, however, in decision block 1190 it was found that an alternate booking was received, processing continues to block 1195 where the consumer's itinerary is updated with the alternate itinerary information. In any case, in block 1185 the consumer is notified of their current status and processing continues to block 1199 where the calling routine is notified that a timely response to the limited availability request was received along with the details (e.g., dates, times rates, etc.) of the response, thereby asynchronously responding to the consumer's original availability request.

As noted above, in one embodiment of the present invention there is an additional agent server 400 in communication with the client device 300. FIG. 12 illustrates one embodiment of interactions between the devices of the asynchronous booking system 200 utilizing such an additional device. The devices of system 200 illustrated in FIG. 12 include a client device 300, agent server 400, agent database 470, inventory server 500, inventory database 570 and inventory manager device 600. The durations of and routines performed by the various devices are similar to the routines illustrated and described in greater detail above with reference to FIGS. 8-11.

Returning to FIG. 12, asynchronous booking is initiated when a client device 300 sends an inventory search query 1202 via the agent server 400 to an agent database 470. The inventory search query results 1204 are returned via the agent server 400 to the client device 300. By having the computationally expensive search and query performed via the agent server for inventory 400, the processing load and bandwidth required for communicating with the more central inventory server 500 is reduced. However, instead of sending the details request 1206 to the agent server 400 for processing, the details request for a selected unit of inventory is sent to the inventory server 500 (via the agent server 400) which is then able to query 1208 the inventory database 570 to receive up-to-date and accurate details query results 1210 which are then forwarded as inventory details 1212 back via the agent server 400 to the client device 300.

Once a consumer has decided on booking a selected unit of inventory, he/she submits an availability request and in this embodiment, payment 1214 to the agent server 400. The agent server 400 then submits a reservation request 1216 to the inventory server 500 and locally stores itinerary details 1220. Additionally, at the inventory server, the reservation request is formatted into a request notice 1218 and the formatted request notice 1222 is then sent to the inventory manager device 600. At some later point an inventory manager uses the inventory manager device 600 to access the inventory server 500 where they receive an authentication prompt 1224. The inventory manager device 600 submits authentication information 1226 to the inventory server which then authenticates 1228 the associated inventory manager with that inventory manager device 600. Once authenticated, the inventory manager device 600 may then submit a request for details 1230 of a limited availability request. The results of their request are returned 1232 to the inventory manager device 600. Once the inventory manager device 600 has the details 1232 they are then able to send out an availability response. The availability response 1234 is sent via the inventory server 500 to the agent server 400. The agent server 400 will then update the consumer's itinerary 1236 and then send out an availability notice 1240 to the consumer's client device 300. The consumer may then request their itinerary 1242 which is returned 1244 from the agent server 400. In any case, as the consumer has already submitted payment, the agent server returns a reservation confirmation 1246 to the inventory server 500, which in turn sends a confirmed reservation notice 1248 to the inventory manager device 600 thereby confirming the asynchronous booking.

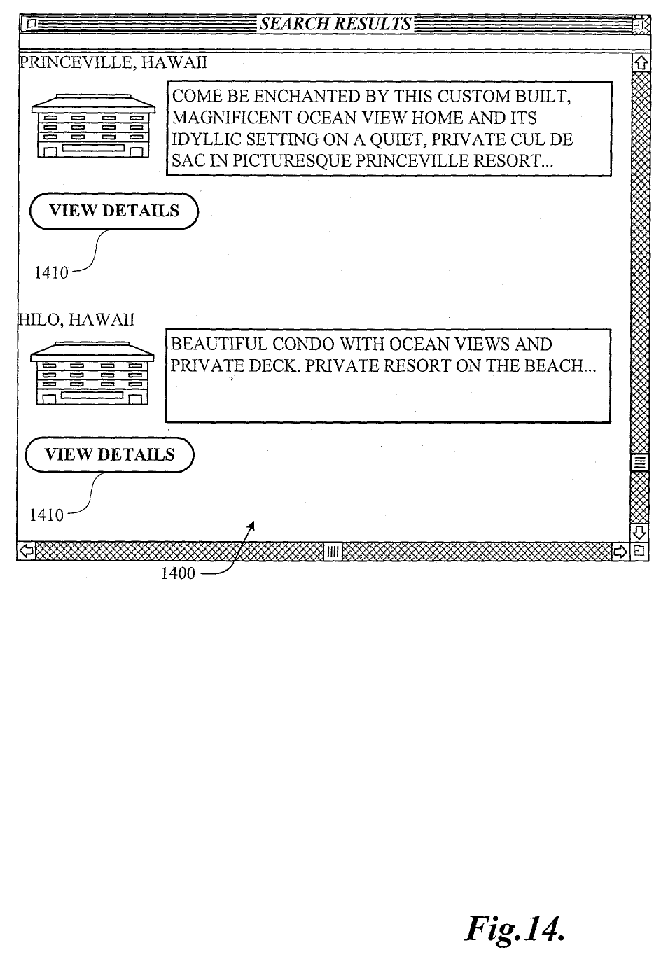

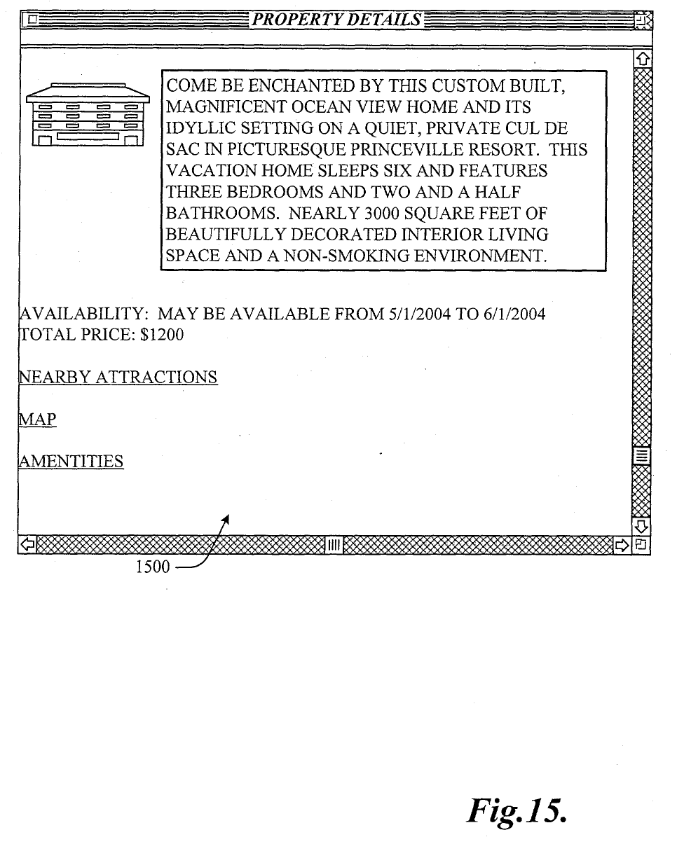

FIGS. 13-19 illustrate exemplary Web pages in accordance with various aspects and phases of the present invention. FIG. 13 illustrates an exemplary Web page 1300 for searching for travel inventory units in accordance with the present invention. FIG. 14 illustrates an exemplary Web page 1400 with search results showing brief information about two properties that match a search request. Also shown in FIG. 14 are view detail buttons 1410 for selecting additional information about a particular property or piece of inventory. FIG. 15 illustrates such a detailed page including links 1500 for further information.

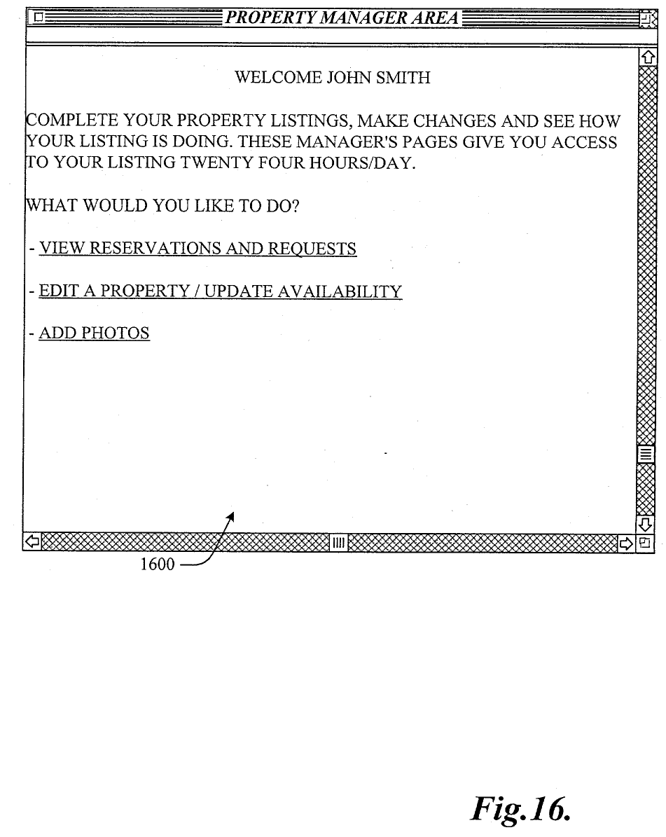

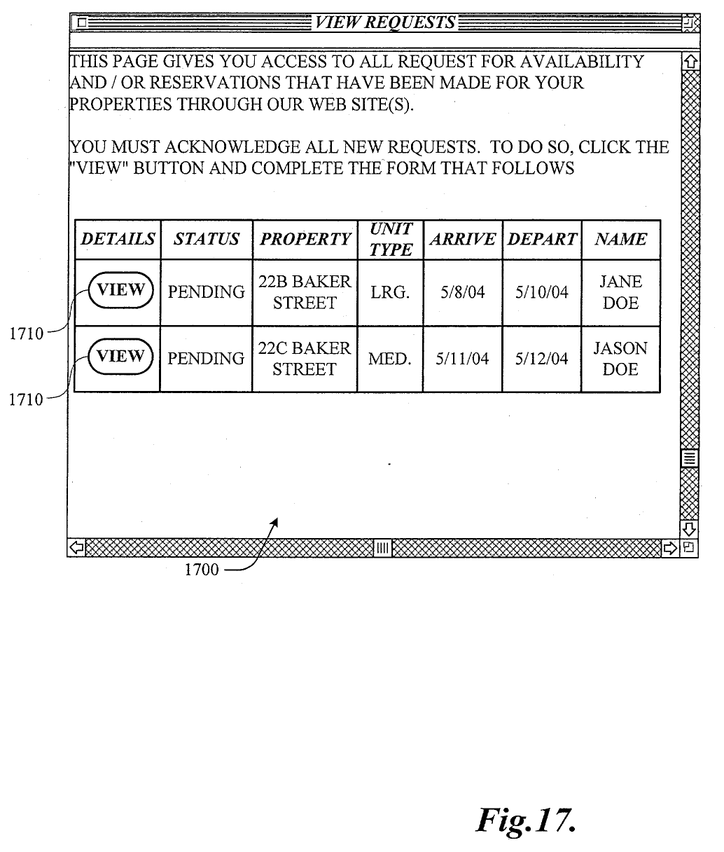

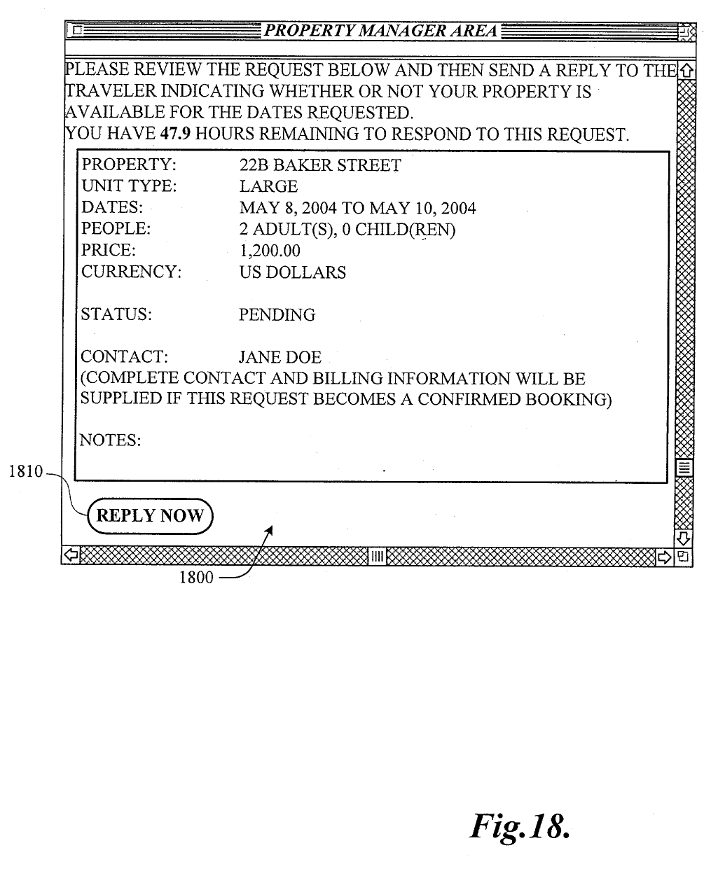

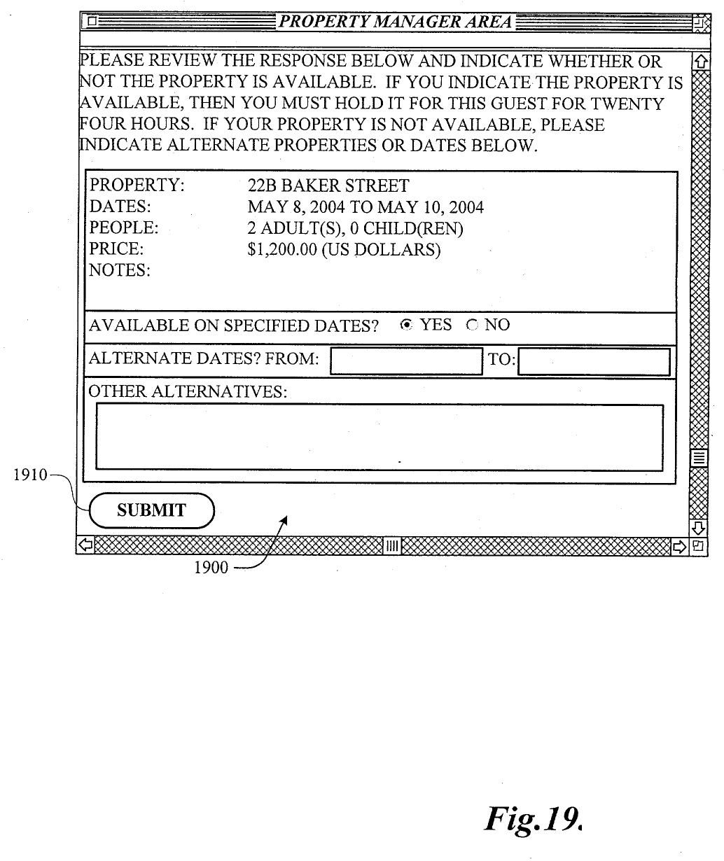

FIGS. 16-19 specifically deal with interactions between an inventory manager and the inventory server 500. FIG. 16 illustrates a welcome screen for an inventory manager who has been authenticated and accessed their personalized Web page on the inventory server 500, included on which is a link 610 for viewing reservations and requests. Clicking on link 1600 might then bring the inventory manager to Web page 1700, illustrated in FIG. 17, showing two pending notices of availability requests. By clicking on the view button 1710 for a particular property or inventory unit, the inventory manager may then address the availability request. By clicking on the view button 710, an inventory manager might then see a Web page, such as Web page 1800, illustrated in FIG. 18, including further information about the availability request from the consumer. Note, however, that until the booking has been confirmed, there will not be any contact or payment information included in such a details request for the inventory manager. By clicking on the reply now button 1810, the inventory manager would then be sent to a Web page such as Web page 1900, illustrated in FIG. 19. Web page 1900 provides the information on the property and the availability to respond with “yes” available, “no” not available, or “no not available and here are alternate dates and/or properties and/or inventory” that might be something the consumer would be willing to substitute. All the inventory manager has to do is fill out any appropriate information and click the submit button to have this information communicated back to the consumer.

As can be seen from the above detailed description, the present invention allows both inventory managers and consumers, who formerly could not arrange for on-line booking to now engage in on-line booking in a convenient and easy to use fashion. While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer-implemented method for booking a travel inventory selection, the method comprising:
receiving an availability request from a client device for a travel inventory selection;
communicating a corresponding limited availability request to an inventory manager device;
asynchronously receiving an availability response to said limited availability request from said inventory manager device; and
confirming booking with said client device and said inventory manager device.

2. The method of claim 1 further comprising receiving an inventory search query from said client device, and providing possible travel inventory selections in response to said inventory search query.

3. The method of claim 2 wherein said travel inventory selection is selected from said possible travel inventory selections.

4. The method of claim 2 further comprising receiving a request for further information on a possible travel inventory selection, and providing more further information on said possible travel inventory selection.

5. The method of claim 1 wherein said limited availability request provides sufficient information to an inventory manager to determine availability, while not providing contact information for a requesting consumer.

6. The method of claim 5 wherein said limited availability request comprises an inventory selection and dates of use.

7. The method of claim 1 wherein said availability request is reflected in an on-line itinerary.

8. The method of claim 7 wherein said availability response is reflected in said on-line itinerary.

9. The method of claim 1 further comprising receiving a request for further information on said limited availability request from said inventory manager device.

10. The method of claim 9 further comprising authenticating an inventory manager prior to providing further information on said limited availability request.

11. The method of claim 1 wherein said availability request includes payment information and wherein once inventory selection availability is acknowledged with said inventory manager device, providing said payment information to said inventory manager device.

12. The method of claim 1 wherein said availability response comprises an alternate travel inventory selection.

13. A computer-implemented method for attempting to book a travel inventory selection, the method comprising:
receiving an availability request from a client device for a travel inventory selection;
communicating a corresponding limited availability request to an inventory manager device; and
after a predetermined time of not receiving a response to said limited availability request, notifying said client device of no availability.

14. The method of claim 13 further comprising tracking the failure rate for an inventory manager device to respond to limited availability requests.

15. A computer server system for booking travel inventory, and operative to:
receive an availability request from a consumer device for a travel inventory selection;
communicate a corresponding limited availability request to an inventory manager device;
after an indeterminate delay, receiving an availability response from the inventory manager device; and
book said travel inventory selection.

16. The computer server system of claim 15 further operative to receive an inventory search request from said client device, process said inventory search request, and return search results comprising at least one possible inventory selection to said client device.

17. The computer server system of claim 16 wherein said travel inventory selection is selected from said search results.

18. The computer server system of claim 16 further operative to respond to a details request for details on one of said at least one possible inventory selections.

19. The computer server system of claim 18 wherein the computer server system is in communication with an inventory server system for responding to said details request.

20. The computer server system of claim 15 wherein the indeterminate delay does not exceed a predetermined time limit.

21. The computer server system of claim 20 wherein said predetermined time limit is between 12 and 72 hours.

22. The computer server system of claim 15 wherein the status of said travel inventory selection is presented in an on-line itinerary.

23. The computer server system of claim 22 wherein said indeterminate delay exceeds a predetermined time limit and said on-line itinerary is updated to reflect a status showing the inventory as unavailable.

24. The computer server system of claim 23 further operative to contact an administrator regarding said indeterminate delay exceeding said predetermined time limit.

25. The computer server system of claim 15 in communication with an agent server and operative to communicate with said client device via said agent server.

26. The computer server system of claim 15 wherein communications between said inventory manager device and said client device are asynchronous.

27. The computer server system of claim 15 wherein booking said travel inventory selection comprises an asynchronous communication with said client device to arrange for payment information to be delivered to said inventory manager device.

28. A computer readable medium containing computer executable code for asynchronously booking travel inventory by:
receiving a travel inventory selection designating an inventory unit and desired time of stay;
notifying an inventory manager device associated with said inventory unit that said travel inventory selection was received;
after a delay, receiving a response from said inventory manager device indicating that hold on said inventory unit is in place;
communicating said response to a client device;
after a delay, receiving acceptance information from said client device; and
booking said inventory unit for the desired time of stay.

29. A computer-readable medium containing computer executable code for booking a travel inventory selection by:
receiving an availability request from a client device for a travel inventory selection;
communicating a corresponding limited availability request to an inventory manager device;
asynchronously receiving an availability response to said limited availability request from said inventory manager device; and
confirming booking with said client device and said inventory manager device.

30. The computer-readable medium of claim 29 further comprising code for receiving an inventory search query from said client device, and providing possible travel inventory selections in response to said inventory search query.

31. The computer-readable medium of claim 30 wherein said travel inventory selection is selected from said possible travel inventory selections.

32. The computer-readable medium of claim 30 further comprising code for receiving a request for further information on a possible travel inventory selection, and providing more further information on said possible travel inventory selection.

33. The computer-readable medium of claim 29 wherein said limited availability request provides sufficient information to an inventory manager to determine availability, while not providing contact information for a requesting consumer.

34. The computer-readable medium of claim 33 wherein said limited availability request comprises an inventory selection and dates of use.

35. The computer-readable medium of claim 29 wherein said availability request is reflected in an on-line itinerary.

36. The computer-readable medium of claim 35 wherein said availability response is reflected in said on-line itinerary.

37. The computer-readable medium of claim 29 further comprising code for receiving a request for further information on said limited availability request from said inventory manager device.

38. The computer-readable medium of claim 37 further comprising code for authenticating an inventory manager prior to providing further information on said limited availability request.

39. The computer-readable medium of claim 29 wherein said availability request includes payment information and wherein once inventory selection availability is acknowledged with said inventory manager device, providing said payment information to said inventory manager device.

40. The computer-readable medium of claim 29 wherein said availability response comprises an alternate travel inventory selection.

41. A computer-readable medium containing computer executable code for attempting to book a travel inventory selection by:
receiving an availability request from a client device for a travel inventory selection;
communicating a corresponding limited availability request to an inventory manager device; and
if a response to said limited availability request has not been received within a predetermined time, notifying said client device of no availability.

42. The computer-readable medium of claim 41 further comprising code for tracking the failure rate for an inventory manager device to respond to limited availability requests.
